(19) United States
(12) Patent Application Publication
(10) Pub. No.: US 2025/0172686 A1
(43) Pub. Date: May 29, 2025

(54) COOPERATIVE INTERFEROMETRIC RECEIVER MODULES, SYSTEMS, AND METHODS FOR TIME AGILE RADAR COMMUNICATION

(71) Applicants: Huawei Technologies Canada Co., Ltd., Kanata (CA); la corporation de l' École Polytechnique de Montréal, Montréal (CA)

(72) Inventors: Intikhab Hussain, Ottawa (CA); Ke Wu, Montréal (CA)

(21) Appl. No.: 19/036,259

(22) Filed: Jan. 24, 2025

Related U.S. Application Data
(63) Continuation of application No. PCT/CA2022/051187, filed on Aug. 4, 2022.

(51) Int. Cl. G01S 13/82; G01S 7/02

(52) U.S. Cl. CPC G01S 13/82; G01S 7/0235

(57) ABSTRACT

The present disclosure provides modules, systems and methods for a cooperative radar-communication (RadCom) wherein transmitters, receivers, and/or transceivers alternate between radar and radio communications in time slots using methods such as time division multiplexing (TDMA), wherein receivers and/or transceivers may be interferometric and the interferometric receivers and/or transceivers may also use balanced detection in radar and communication modes for providing modules, systems and methods requiring a lower dynamic range resulting in increased performance and lower power consumption requirements. An embodiment of the present disclosure relates to modules, systems and methods for radar using transmitters, receivers, transceivers, and/or radio using interferometric receivers and/or transceivers using balanced detection.

### CROSS-REFERENCE TO RELATED APPLICATION

This application is a continuation of PCT International Application Ser. No. PCT/CA2022/051187 filed on Aug. 4, 2022, the content of which is incorporated herein by reference in its entirety.

### TECHNICAL FIELD

The present disclosure relates generally to radar-communication systems, and in particular, to radar-communication systems using interferometric receivers.

### BACKGROUND

Systems and methods providing combined wireless communication and radar sensing capabilities permit more efficient use of limited electromagnetic spectrum, which is desirable to prevent under-utilization in applications where spectral resources are strictly allocated. Further, the combination of radar and radio operational modes provides additional functionality in the form of intelligent wireless platforms. As a result, there is an increasing demand for operation-sharing systems, methods, platforms, and/or the like for dual-functional radar sensing and data communication or radar-communication (RadCom). Advantages of multifunction systems include compact dimensions, low cost, high efficiency, functional interplay, complementary components, and/or low power consumption. Communications systems featuring interaction of two or more cooperative transceivers is fundamentally different from the classic radar systems. Traditional radar systems measure echoes of uncooperative, passive targets, operate according to known radar equations, and are susceptible to scattering difficulties and range limitations. Unified RadCom systems generally require a receiver front-end having a high dynamic range as path loss for individual functions varies by a factor of 1/R², where R is an operational range of a receiver.

### SUMMARY

The present disclosure provides modules, systems, and methods for a cooperative radar-communication (RadCom) wherein transmitters, receivers, and/or transceivers alternate between radar and radio communications in time slots using methods such as time division multiplexing (TDMA), wherein receivers and/or transceivers may be interferometric and/or use balanced detection for providing modules, systems, and methods requiring a low dynamic range, thereby resulting in increased performance and low power consumption requirements.

In a broad aspect, a module includes a transmitter and a receiver. The transmitter is for transmitting an originating radar sweep signal and an originating radio signal to a cooperating module in different first time slots. The receiver is for receiving a cooperating radar sweep signal and a cooperating radio signal transmitted from the cooperating module in different second time slots. The module is configured for processing the cooperating radar sweep signal to determine a distance between the module and the cooperating module and a velocity of the cooperating module relative to the module, and processing the cooperating radio signal to extract cooperating radio signal data.

In an embodiment, the receiver is an interferometric receiver.

In an embodiment, the module has balanced radar detection for processing the cooperating radar sweep signal.

In an embodiment, the module has balanced radio detection for processing the cooperating radio signal.

In an embodiment, the different first time slots and the different second time slots are each arranged based on a time-division multiple access (TDMA) method.

In an embodiment, the originating and cooperating radar sweep signals are triangular frequency-modulated continuous waves.

In an embodiment, the receiver is configured for receiving the cooperating radar sweep signal and the cooperating radio signal from two or more cooperating modules.

In an embodiment, the transmitter is configured to transmit the originating radar sweep signal after an originating time delay following a start of one of the first time slots.

In an embodiment, the module is configured to extract a cooperating time delay from the cooperating radar sweep signal, the cooperating time delay being distinctly associated with a particular cooperating module.

In an embodiment, the cooperating radio signal data includes beat frequency information of the cooperating radar sweep signal.

In a broad aspect, a module includes a transmitter and an interferometric receiver. The transmitter is for transmitting an originating radar sweep signal to a cooperating module. The interferometric receiver is for receiving a cooperating radar sweep signal from the cooperating module. The module is configured for processing the cooperating radar sweep signal to determine a distance between the module and the cooperating module and a velocity of the cooperating module relative to the module.

In a broad aspect, a method includes: in a first time slot, transmitting an originating radar sweep signal from a module to a cooperating module and sensing for a cooperating radar sweep signal from the cooperating module, and in a second time slot, transmitting an originating radio signal from the module to the cooperating module and sensing for a cooperating radio signal from the cooperating module.

### BRIEF DESCRIPTION OF THE DRAWINGS

For a more complete understanding of the disclosure, reference is made to the following description and accompanying drawings, in which:

FIG. 1 is a schematic of an embodiment of a radar-communication system;

FIG. 2 are graphs showing radiofrequency (RF) and intermediate frequency (IF) plots as a function of time of the radar-communication system shown in FIG. 1, according to an embodiment of the present disclosure, wherein the RF is input in the radar-communication system and IF is produced by the radar-communication system;

FIG. 3 is a block diagram of an embodiment of a module of the present disclosure;

FIG. 4 is a flowchart of a method of operation of an embodiment of a module of the present disclosure;

FIG. 5A is a schematic illustrating operation of an embodiment of a module of the present disclosure;

FIG. 5B is a block diagram of a multiport junction for balanced detection of an embodiment of a module of the present disclosure;

FIG. 6 is a graph showing simulated S-parameters as function of frequency of a multiport network of the present disclosure;

FIG. 7 is a graph showing simulated output in-phase and quadrature (IQ) signal components as a function of time relating to an embodiment of a module of the present disclosure;

FIG. 8 is a graph showing characterization of a rectified wave of an embodiment of a module of the present disclosure;

FIG. 9A is a graph showing a received IQ-waveform of an embodiment of a module of the present disclosure;

FIG. 9B is a graph showing the demodulated IQ-waveform of FIG. 9A;

FIG. 10 is an image of a prototype of an embodiment of a module of the present disclosure;

FIG. 11A to FIG. 11F are graphs showing measured characteristics of the prototyped module of FIG. 10;

FIG. 12 is a block diagram of a test measurement setup for measuring beat signals at a first module of the present disclosure;

FIG. 13 is a graph illustrating measured power spectral density of the first module of FIG. 12;

FIG. 14A is a block diagram of a test measurement setup for measuring beat signals at a second module of the present disclosure;

FIG. 14B is a graph illustrating measured power spectral density of the second module of FIG. 14A;

FIG. 15A is a graph illustrating measured distance as a function of defined distance of an embodiment of a module of the present disclosure;

FIG. 15B is a graph illustrating measured velocity as a function of defined velocity of an embodiment of a module of the present disclosure;

FIG. 16 is a graph illustrating distance-velocity measurements of an embodiment of a module of the present disclosure for an approaching target;

FIG. 17 is a graph illustrating beat signal measurements as a function of frequency of an embodiment of a module of the present disclosure;

FIG. 18A is a block diagram of a test measurement setup for measuring communication functions of a module of the present disclosure;

FIG. 18B are normalized constellation diagrams of recovered baseband signals of an IF channel of an embodiment of a module of the present disclosure;

FIG. 18C is a graph illustrating error vector magnitude (EVM) as a function of RF input power of an embodiment of a module of the present disclosure;

FIG. 19 is an image of a prototype module of an embodiment of a module of the present disclosure;

FIG. 20 is a graph illustrating IF output power as a function of RF input power of an embodiment of a module of the present disclosure;

FIG. 21 is a graph illustrating an output IQ-signal components as a function of time of an embodiment of a module of the present disclosure;

FIG. 22A are normalized constellation diagrams of recovered baseband signals of an embodiment of a module comprising single-ended detection of the present disclosure; and

FIG. 22B are normalized constellation diagrams of recovered baseband signals of an embodiment of a module comprising balanced detection of the present disclosure.

### DETAILED DESCRIPTION

Unless otherwise defined, all technical and scientific terms used herein generally have the same meaning as commonly understood by one of ordinary skill in the art to which this disclosure pertains. Exemplary terms are defined below for ease in understanding the subject matter of the present disclosure.

Systems and methods providing dual-functional radar sensing and data communication or radar-communication (RadCom) permit more efficient use of limited electromagnetic spectrum and provides additional functionality in the form of intelligent wireless platforms. Many RadCom systems integrate functionality with a single hardware platform, wherein radar and radio signal processing functionalities are separated in frequency-domain, code-domain, and/or time-domain using conventional mixer-based receiver topologies. In some embodiments disclosed herein, transmission of radar and radio signals occurs in different time slots that are set to minimize any potential interference between the two signals.

Systems and methods comprising a radar system equipped with an active transponder reduce range limitations, in accordance with the Friis transmission equation (see, for example, https://www.ece.mcmaster.ca/faculty/nikolova/antenna_dload/current_lectures/L06_Friis.pdf, the content of which is incorporated herein by reference in its entirety). Distance measurements can be effectively conducted where active stations are accurately synchronized. The occurrence of synchronization errors within such applications have a negative effect on measurement results. Cooperative frequency modulated continuous wave (FMCW) radar stations have been used for making distance measurements, wherein data transfer in a master-slave configuration between the stations reduces the effect of synchronization inaccuracies by inherently eliminating the unknown offset times.

From the Friis equation, it can be derived that radio communication systems require a dynamic range of 20 log(Rₘₐₓ/Rₘᵢₙ), where Rₘₐₓ and Rₘᵢₙ are the maximum and minimum distance ranges of a receiver (which may be the maximum and minimum signal-receiving distance ranges of the receiver in a communication system or the maximum and minimum sensing distance ranges of the receiver in a radar system), respectively. From the radar equation (see, for example, https://www.mathworks.com/help/radar/ug/radar-equation.html, the content of which is incorporated herein by reference in its entirety), it can be derived that non-cooperative radar systems require a dynamic range of 40 log(Rₘₐₓ/Rₘᵢₙ)+(σₘₐₓ−σₘᵢₙ), where σₘₐₓ and σₘᵢₙ are the maximum and minimum radar cross-section (RCS) of a target, respectively. As an example, assuming the same antenna gain in both minimum and maximum cases, and Rₘₐₓ=300 m, Rₘᵢₙ=30 m, σₘₐₓ=40 dBm² and σₘᵢₙ=0 dBm², a non-cooperative radar system requires an excess of 60 dB dynamic range when compared to a radio communication system. The difference in dynamic ranges of a RadCom system for similar operational range in both the radar and communication modes can be even greater when large and small objects are detected at short and long distances, respectively.

Cooperative systems comprising a communication link that reduces negative impacts of synchronization inaccuracies generally use conventional switching mixer-based receiver topologies and are used for local positioning and distance measurements. Unified RadCom systems generally require a receiver front-end having a high dynamic range configured for a common operational range for both radar and communication modes. Current RadCom systems are based on conventional mixer-based receiver topologies which require a high-power local oscillator (LO) for driving signal power levels for its switching operation.

In some embodiments of the present disclosure, a cooperative RadCom system architecture comprises a multi-port interferometer receiver suitable for low-power and low-cost multifunction wireless applications, such as air taxi and unmanned aerial vehicle (UAV) applications. In some embodiments of the present disclosure, cooperative RadCom systems do not require a receiver front-end having a high dynamic range comprising the operational ranges for both radar and communication modes, as cooperative radar range limitations are limited in accordance with the Friis equation. Some embodiments of the present disclosure comprise a low-power interferometric receiver which operates based on power detection principles and uses a balanced detection method. An interferometric receiver using a balanced detection method can operate on a quarter of the driving signal power to provide performance having a similar error rate as interferometric receivers based on a single-ended detection method. Interferometric receivers comprising balanced detection methods as disclosed herein significantly reduces undesired interference, which may be generated between radar echoes and cooperative radio responses, and the detection of false targets.

In some embodiments of the present disclosure, a low-power interferometric receiver architecture is used to provide a cooperative multifunction system for obtaining distance and velocity measurements having data communication capability using different time slots within a single hardware platform. Some embodiments of architectures comprising interferometric receivers as described herein provide a number of advantages over conventional mixer-based topologies, such as enhanced broadband capability, lower power requirements for detection operation, more cost-effective structure designs, and robustness for power level variations. As a result, such architectures have been used in connection with architecture developments for multi-function systems. Interferometric receivers work on the principle of additive mixing, which combines input signals followed by a non-linear processing element. Conventional multiport direct-conversion receivers are comprised of single-ended power detectors (which determine a receiver dynamic range) operating in a square-law region as additive mixing elements for frequency translation through a multiport interference. Low-pass detected signals have a desired signal component, which is used for the baseband signal regeneration, together with the systematically generated rectified-wave components. Rectified wave composition for second-order nonlinearity may provide undesired baseband signal generation produced by the spectral convolution of RF-signal, which may cause frequency-mixing components to be generated between radar echoes and cooperative radar responses.

In some embodiments disclosed herein, systems and methods comprise a balanced detection method using direct-conversion interferometric receivers to suppress rectified wave composition for second-order nonlinearity and to enhance detected signal quality. The systems and methods rely on differential acquisition of received signals at the detection stage which retains useful beat signal components for information extraction. In radar mode, a balanced detection method is used to suppress frequency-mixing components generated between radar echoes and cooperative radar responses to eliminate undesired interference and false targets. Embodiments of the present disclosure provide energy-efficient, multi-functional, and reconfigurable smart wireless systems comprising multi-port interferometric receivers for low-power and low-cost solution for the front-end reception of RadCom systems and applications.

In some embodiments disclosed herein, systems and methods operate in both radar and radio communication modes, which may occur in different time slots using a single hardware platform. In the radar mode, a triangular FMCW method can be used for distance and velocity measurements. A radio cycle following a radar cycle can be used to communicate beat frequency information among different modules or measurement stations for cooperative radar operation, which can also be used for any other data transmissions. The interferometric receiver (a low-power receiver architecture comprising a dynamic range limited by linearity of power detectors for frequency translation) for a unified multi-function operation that benefits from a cooperative system design as it does not require a receiver front-end having a high dynamic range. The receiver architecture uses a balanced detection method to suppress the frequency mixing components generated between radar echoes and cooperative radar responses, eliminating undesired interferences and false targets. Further, a balanced detection method can improve conversion gain of received frequency components by 6 dB as compared to conventional multiport interferometric receivers using a single-ended detection method.

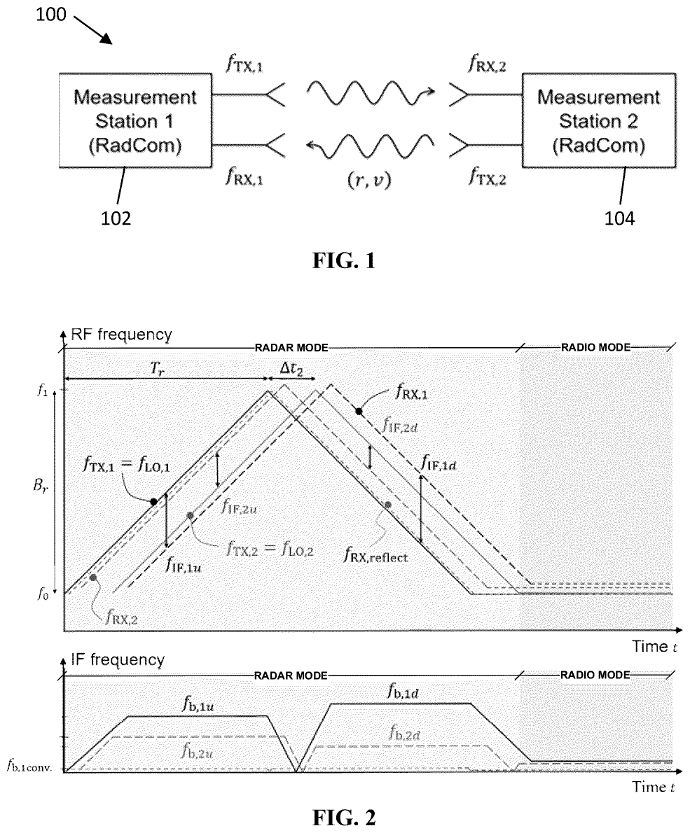

A multifunction cooperative system generally comprises two or more active measurement stations. FIG. 1 illustrates a basic multifunction cooperative system 100 comprising two measurements stations, a first measurement station 102 and a second measurement station 104, wherein each measurement station 102, 104 is configured for wireless communication and radar sensing sequentially arranged in time-domain. FIG. 2 show plots of frequency-time illustrating different stages of measurement of the multifunction cooperative system. Each measurement station 102, 104 generates a triangular sweep signal in a radar cycle that is used for transmission as well as a LO reference signal for frequency translation. In some embodiments, frequency-modulated signals from different measurement stations are delayed with an arbitrary time delay Δtₙ (where n is the total number of measurement stations), which permits measurement stations to distinguish radar echoes from cooperative radar responses present in the cooperative system. Separating different stations using different time delays permits scaling of the cooperative system to a plurality of stations where distance and velocity measurements are free from potential ghost targets. The transmit (TX) signal from the first measurement station 102 is received (RX) at the second measurement station 104, or vice-versa, wherein the RX signal is down-converted using the LO reference signal. In an embodiment disclosed herein, the frequency of intermediate frequency (IF) signal depends on distance r and relative velocity v between the first station 102 and the second station 104. The IF frequency is also dependent on the chosen time delay, which allows distinguishing different stations in the frequency domain. During a radio cycle, calculations can be performed on frequency observations obtained during a radar cycle to obtain distance and relative velocity measurements of a target station. A radio cycle can also be used for the transmission of other data.

In some embodiments disclosed herein, the first measurement station 102 and the second measurement station 104 are modules. In some embodiments disclosed herein, when describing the module comprising the first measurement station 102, the term cooperating module will be used to refer to other modules in the multifunction cooperative system comprising the second measurement station 104. FIG. 3 illustrates a block diagram of an embodiment of a module 300 comprising a transmitter block 302 and a receiver block 304, wherein in some embodiments disclosed herein, a multifunction cooperative arrangement of system comprises the module 300, acting as the first measurement station 102, and one or more cooperating modules. In some embodiments disclosed herein, the transmitter block 302 and the receiver block 304 are discrete physical elements interconnected with other components to form the module 300. In some embodiments disclosed herein, the transmitter block 302 and the receiver block 304 are discrete logical functions of a common physical transceiver element, sharing circuits, components, and/or the like. In some embodiments disclosed herein, the transmitter block 302 or transmitter is for transmitting an originating radar sweep signal and an originating radio signal to a cooperating module and the receiver block 304 or receiver is for receiving a cooperating radar sweep signal and a cooperating radio signal transmitted from the cooperating module, wherein the radar sweep signals and the radio signals are transmitted and received in different time slots. In some embodiments disclosed herein, the transmitter 302 and the receiver 304 alternate between radar and radio communications in time slots using methods such as time division multiplexing (TDMA). In some embodiments disclosed herein, the module 300 or receiver 304 is configured for processing the cooperating radar sweep signal to determine a distance between the module and the cooperating module and a velocity of the cooperating module relative to the module, and processing the cooperating radio signal to extract cooperating radio signal data.

In some embodiments disclosed herein, a module configured for radar-only comprises a transmitter and an interferometric receiver, wherein the transmitter for transmitting an originating radar sweep signal to a cooperating module, and the interferometric receiver for receiving a cooperating radar sweep signal from the cooperating module. In some embodiments disclosed herein, the module is configured for processing the cooperating radar sweep signal to determine a distance between the module and the cooperating module and a velocity of the cooperating module relative to the module. While embodiments of the present disclosure for modules for radar-only do not have all of the benefits of some other embodiments of modules disclosed herein, the use of an interferometric receiver in a non-cooperative system still provides many of the benefits described herein, especially when using a balanced detection method.

A transmitted signal s_{TX,i}(t) of a transmitting station such as the first measurement station 102 with index i (i=1, 2, . . . , n) can be represented by

$${s}_{TX , i} ( t ) = A cos ( {φ}_{T X , i} ( t ) ) \qquad ( 1 )$$

where A represents the amplitude of the signal. The expression of the IF signal can be derived for each sweep time Tᵣ in the radar cycle as shown in FIG. 2. The phase φ_{Tx,i}(t) of an upchirp can be expressed as

$${φ}_{TX , i} ( t ) = 2 π ( ( {f}_{0} - {k}_{r} Δ {t}_{i} ) t + {k}_{r} {t}^{2} / 2 ) \qquad ( 2 )$$

where f₀ is the sweep start frequency for upchirp, kᵣ is the slope of the chirp defined by sweep bandwidth Bᵣ and the sweep time, that is kᵣ=Bᵣ/Tᵣ, and Δtᵢ is originating time delay at the transmitting station with index i (i=1, 2, . . . , n). The cooperating module (also denoted the “receiving station” hereinafter) such as the second measurement station 104 receives s_{TX,i}(t) after the time delay, in case of an outgoing target (for example, the second measurement station 104 moving away from the first measurement station 102),

$${τ}_{i , j} = \frac{{r}_{i , j} + {v}_{i , j} t}{c} \qquad ( 3 )$$

where j=1, 2, . . . , n represents the receiving station index, c is the speed of light, r_{i,j} is the distance between the transmitting station 102 with index i and receiving station 104 with index j, v_{i,j} is the relative velocity between the transmitting station 102 with index i and receiving station 104 with index j, and τ_{i,j} is the time delay to receive the transmitted signal from the transmitting station 102 with index i at the receiving station 104 with index j. A receiver mixer performs a frequency conversion of the received radiofrequency (RF) signal using its reference LO signal. In an FMCW radar, only the low frequency IF components are used, which results in the IF phase of a first measurement station 102:

$${φ}_{IF , 1 u} ( t ) = {φ}_{TX , 1} ( t ) - {φ}_{TX , 2} ( t - {τ}_{1 , 2} ) = 2 π ( {k}_{r} Δ {t}_{2} ( t - {τ}_{1 , 2} ) + {f}_{0} {τ}_{1 , 2} + {k}_{r} {τ}_{1 , 2} ( t - {τ}_{1 , 2} / 2 ) ) \approx 2 π \underbrace{( {f}_{0} {v}_{12} + {k}_{r} {r}_{12} + {k}_{r} Δ {t}_{2} )}_{frequency} t + \underbrace{2 π ( {f}_{0} {r}_{12} - {k}_{r} {r}_{12} ( {r}_{12} / 2 + Δ {t}_{2} ) )}_{phase} \qquad ( 4 )$$

where v₁₂=v_{1,2}/c and r₁₂=r_{1,2}/c. To derive (4), Δt₁=0 and v_{1,2}<<c, which is valid for most practical applications, are assumed. Accordingly, the IF phase of second station becomes

$${φ}_{IF , 2 u} ( t ) = {φ}_{TX , 2} ( t ) - {φ}_{TX , 1} ( t - {τ}_{2 , 1} ) = 2 π ( {f}_{0} {τ}_{2 , 1} - {k}_{r} Δ {t}_{2} t + {k}_{r} {τ}_{2 , 1} ( t - {τ}_{2 , 1} / 2 ) ) \approx 2 π ( {f}_{0} {v}_{21} + {k}_{r} {r}_{21} - {k}_{r} Δ {t}_{2} ) t + 2 π ( {f}_{0} {r}_{21} - {k}_{r} {r}_{21}^{2} / 2 ) \qquad ( 5 )$$

where v₂₁=v₁₂=v is the relative velocity between the first measurement station 102 and the second measurement station 104 and r₂₁=r₁₂=r is the distance between the first measurement station 102 and the second measurement station 104. The transfer of these beat signals, represented as f_{b,1u} and f_{b,2u}, in the radio cycle between these two stations results in

$${f}_{b , 1 u} + {f}_{b , 2 u} = ( {f}_{0} v + {k}_{r} r + {k}_{r} Δ {t}_{2} ) + ( {f}_{0} v + {k}_{r} r - {k}_{r} Δ {t}_{2} ) = {f}_{0} 2 v + {k}_{r} 2 r \qquad ( 6 )$$

Equation (6) indicates that the beat signal is related to the distance and relative velocity between the two stations and can be calculated by combining the beat signals in the upchirp and downchirp. In the same way, the beat signals of the downchirp can be expressed as:

$${f}_{b , 1 d} + {f}_{b , 2 d} = ( {f}_{1} v - {k}_{r} r - {k}_{r} Δ {t}_{2} ) + ( {f}_{1} v - {k}_{r} r + {k}_{r} Δ {t}_{2} ) = {f}_{1} 2 v - {k}_{r} 2 r \qquad ( 7 )$$

where f₁ is the sweep start frequency for downchirp. It is assumed that the radial velocity remains relatively constant over a full duration of the chirp and it is sufficiently low so that the target does not move sufficiently over the full duration of the chirp, which are reasonably true depending on applications. The upchirp and downchirp slopes are set to equal in this solution. In the radio cycle, these beat frequencies are communicated between these two stations in a time division mode. They are then used to determine the relative velocity and distance between the stations. In a multi-station environment, kᵣΔtᵢ term with arbitrary time delay allows to separate the targets in the frequency domain.

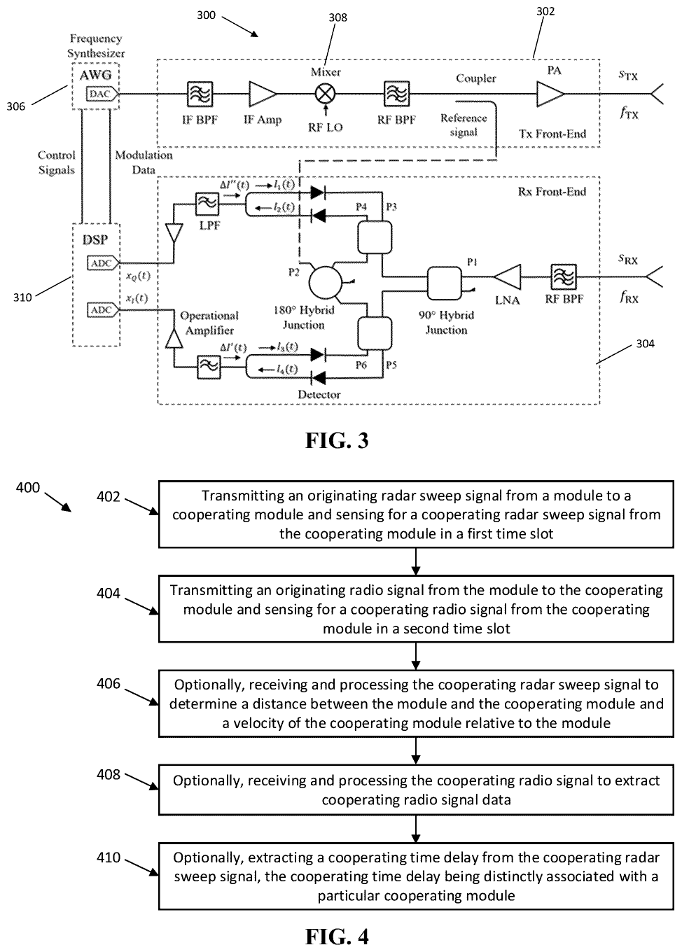

In some embodiments disclosed herein, a transmitter 302 and a receiver 304 of a module 300 alternate between radar and radio communications in time slots using methods such as TDMA. FIG. 4 illustrates the steps of an embodiment of a method 400 of operation of a module 300 for a cooperative RadCom system. The method 400 begins with transmitting an originating radar sweep signal from a module to a cooperating module and sensing for a cooperating radar sweep signal from the cooperating module in a first time slot at step 402. At step 404, an originating radio signal is transmitted from the module to the cooperating module and a cooperating radio signal is sensed for from the cooperating module in a second time slot. At step 406, optionally, the cooperating radar sweep signal is received and processed to determine a distance between the module and the cooperating module and a velocity of the cooperating module relative to the module. In some embodiments disclosed herein balanced radar detection is used to process the radar sweep signal. At step 408, optionally, the cooperating radio signal is received and processed to extract cooperating radio signal data, including for extracting beat frequency information of the cooperating radar sweep signal. In some embodiments disclosed herein balanced radio detection is used to process the radio sweep signal. In some embodiments disclosed herein, the originating radar sweep signal is transmitted after a distinct originating time delay. At step 410, optionally, a cooperating time delay is extracted from the cooperating radar sweep signal, the cooperating time delay being distinctly associated with a particular cooperating module.

In some embodiments disclosed herein, the time-domain integration methods in the measurement stations are synchronized using a data exchange among measurement stations prior to operation. However, synchronization inaccuracies generally do not impact sensing measurement results as delay time from the ramp portion of triangular signals minimizes the effects of such inaccuracies. The required synchronization accuracy is determined by the maximum IF-frequency of analog-to-digital converters (ADCs) of the modules 300. For example, given a sweep slope kᵣ of 150 MHz/20 ms and maximum processible IF-frequency of 35 MHz, a trigger delay, being the delay of actual transmission from the start of a given transmission cycle, must be less than 4.67 ms if time-of-flight of a signal is ignored. Therefore, a maximum delay and equivalent synchronization accuracy is in the range of a few milliseconds. In some embodiments disclosed herein, a synchronization accuracy in the range of 100 ns can be achieved using a data transfer between measurement stations. In another example, a module has a synchronization accuracy in the range of 100 ps and an IF-frequency of 10 Hz, with a FMCW signal. The synchronization principle demonstrates that offsets can be addressed using a set of linear equations requiring the upsweep and downsweep beat frequencies of a triangular modulated FMCW signal. Time delay Δtₙ information among RadCom measurement stations can be exchanged in a radio cycle prior to the obtaining measurements.

In a radio cycle, each measurement station works in a dedicated time slot based on a TDMA method. For example, when a first station receives data signal from a second station, the unmodulated signal at first station is used as a reference signal for data demodulation. A baseband carrier recovery method can also compensate for the Doppler spread in the radio cycle.

FIG. 3 illustrates a transceiver architecture of a module 300. In an embodiment, an arbitrary waveform generator (AWG) 306 is used to generate a radar-communication waveform, which is then up-converted in the 5.8 GHz band through a mixer 308. A digital signal processing (DSP) module 310 serves as central controller and evaluation unit. Apart of transmit signal is used as a reference signal for the quadrature demodulation. An interferometric receiver operates on the principle of additive mixing in a balanced method, which retains only the useful beat signal components and cancels unwanted rectified signals generated systematically in a conventional interferometric receiver. The received RF-signal and reference LO-signal fed into the kth power detector operating in its square-law region can be written as:

$${y}_{k} ( t ) = α A cos ( {φ}_{T X , i} ( t ) + {φ}_{k} ) + βcos ( {φ}_{RX , i} ( t ) + {θ}_{k} ) \qquad ( 8 )$$

where αA and β represent the amplitude of reference and received signals, respectively. φₖ and θₖ represent the phase shift induced in the reference and received signal path, respectively. The low-pass detected interferometric signals can be expressed as:

$${I}_{k} ( t ) = R \cdot ( \underbrace{{α}^{2} {A}^{2} / 2 + {β}^{2} / 2}_{rectified wave} + \underbrace{2 α A βcos ( {φ}_{TX , i} ( t ) - {φ}_{RX , i} ( t ) + {φ}_{k} - {θ}_{k} )}_{desired signal} ) \qquad ( 9 )$$

where R represents the diode responsivity. Those skilled in the art will appreciate that the power detection operation is not limited to using diode elements and may be extended to using transistors elements. The systematically generated rectified wave components at the output single-ended detectors (a detection method employed in a conventional multiport receiver) represent the self-mixing of reference signal, the first term in equation (9), the self-mixing of received signals, and the second term in equation (9). The desired signal representing the mixing of reference and received signals, the third term in equation (9).

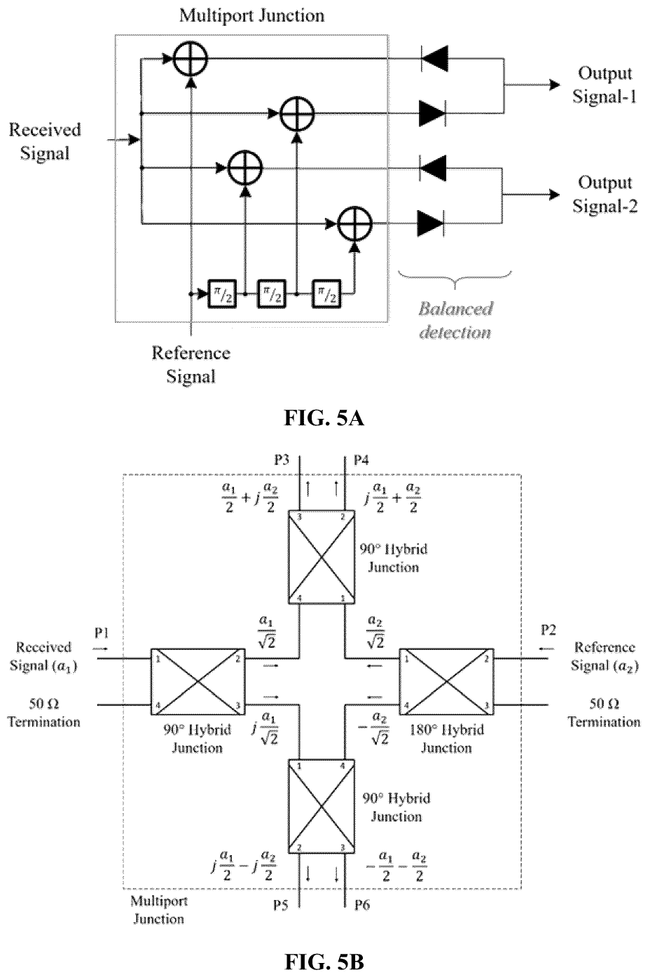

FIG. 5A illustrates the operation of an embodiment of a direct-conversion interferometric receiver with a balanced detection method, wherein mixing elements comprise diodes or transistors, wherein a received signal is combined with a reference signal at one or more multiport junction then passes through the balanced detection method. FIG. 5B is a block diagram of a multi-port junction comprising three 90° hybrid junctions and one 180° hybrid junction providing the necessary essential phase requirements for balanced detection. Referring to FIG. 5B, a first port (P1) is for receiving an RF-signal, a second port (P2) is for receiving a reference LO-signal and the third port (P3), fourth port (P4), fifth port (P5) and sixth port (P6) are outputting IF-signals.

In some embodiments disclosed herein, the balanced detection method used operates based on phase opposition of the reference signal measured between a pair of Schottky diodes. The subtraction of two outputs is set to cancel unwanted rectified signals and improve the desired detected signal quality. The multiport interferometric receiver junction comprises of three 90° hybrid and one 180° hybrid that satisfies the essential phase conditions for balanced detection as illustrated in FIG. 5B. The balanced detected in-phase (I) and quadrature (Q) signal components can be expressed as:

$$Δ {I}^{′} ( t ) = 4 α A β R cos ( {φ}_{TX , i} ( t ) - {φ}_{R X , i} ( t ) ) \qquad ( 10 a )$$

$$Δ {I}^{″} ( t ) = - 4 α A β R sin ( {φ}_{T X , i} ( t ) - {φ}_{RX , i} ( t ) ) \qquad ( 10 b )$$

Further, balanced detection also doubles the desired detected currents which improves the conversion gain of received frequency components by 6 dB when compared to a conventional interferometric receiver with the single-ended detection method counterpart. System noise may also be reduced as common-mode noise can be canceled out. In the radar mode, the balanced detection method suppresses the frequency mixing components between received radar echoes and cooperative radar responses, which can avoid undesired interference and false targets.

A complex-baseband architecture in the context of a FMCW radar can provide a theoretical 3 dB improvement of noise parameters by eliminating image-band noise foldback when compared to real baseband implementations. This provides robustness against any interference present in the image-band. Another advantage is that minimum output interface rate of data converters required is equal to the maximum beat frequency.

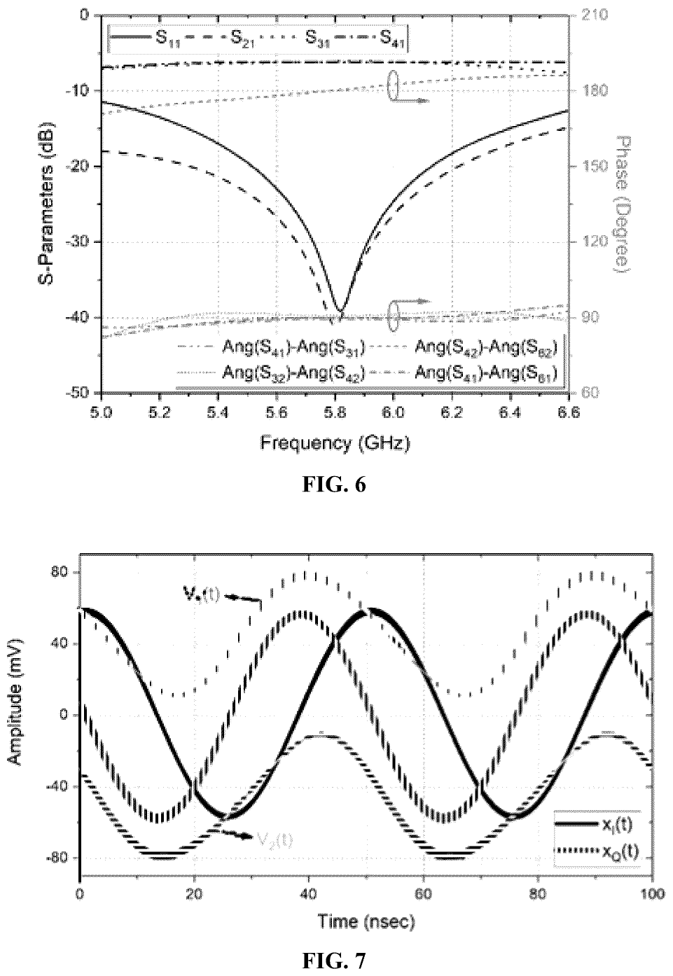

FIG. 6 and FIG. 7 illustrate simulation results of an embodiment of a multiport junction described herein, integrated with diode-based power detectors and other passive components using co-simulations. Referring to FIG. 6, multiport junction scattering parameters (S-parameters) are shown. The amplitude and phase error of the junction is less than 0.23 dB, equivalent to a margin of error of 2.7%, and 4.5° between 5.4 and 6.2 GHz. FIG. 6 further illustrates simulated output IQ-signal components, demonstrating operation of the disclosed receiver, where the balanced detection method cancels the rectified components generated from the individual detectors and doubles the amplitude of a detected IF signal. FIG. 7 illustrates simulated output IQ-signal components of an embodiment of the receiver disclosed herein as a function of time when continuous wave (CW) signals are at f_{RF}=5.8-GHz and f_{LO}=5.82-GHz. V₁(t) and V₂(t) are the node voltages at the output of single-ended power detectors.

Some embodiments disclosed herein comprising a balanced detection method provide additional benefit in multiport interferometric receivers in a multichannel radio propagation environment, where multiple sub-signals exist in the frequency band of interest.

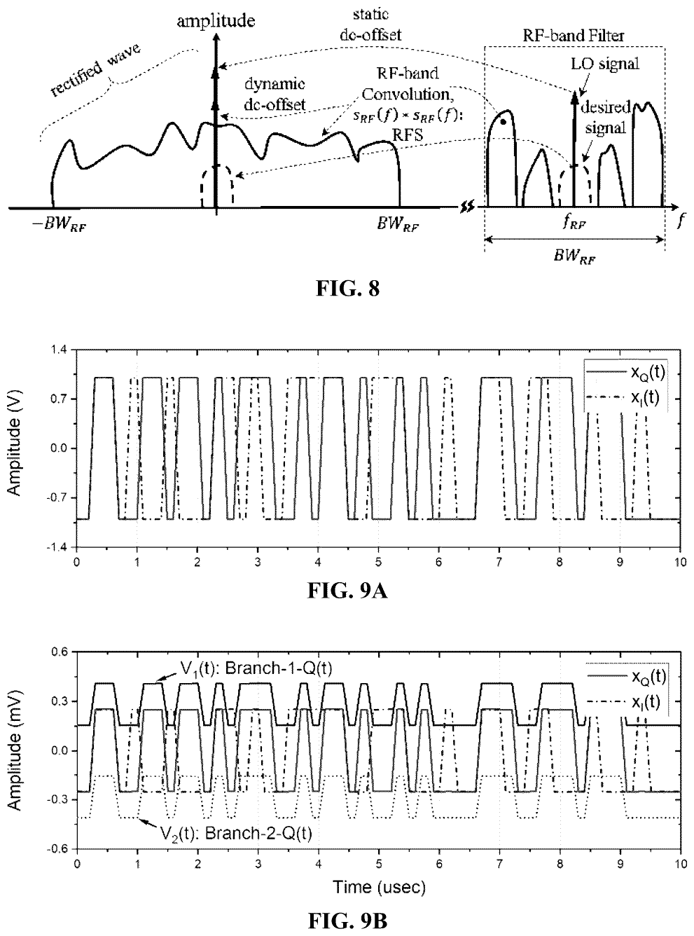

In multiport interferometric receivers, a rectified wave represents the systematic generation of a static direct-current (dc) offset and an intermodulation product (IMP) of a RF signal. A RF self-mixing (RFS) product representing IMP of the RF signals is highly related to temporal and power changes and the number of subsignals. It encompasses a strong dynamic dc offset generated by the spectral convolution of the RF signal. The dc offset is one of the most crucial factors in the baseband section of an analog direct-conversion receiver following the mixer, which should preferably be removed before the ADC to gain an appreciable dynamic range for the desired signal. The static dc offset is quasi-constant for a short duration and can be compensated in the analog domain. The rectified wave composition for the second-order nonlinearity shows an undesired baseband signal generation as shown in FIG. 8, which is highly dynamic in nature and affects the performance of the multiport direct-conversion receiver. The dynamic dc offset in an ideal square-law power detector region is:

$${P}_{RFS , D C} [ dB ] = 2 \cdot {\hat{P}}_{R F} [ dB ] + 20 {log}_{10} ( q ) \qquad ( 11 )$$

where \hat{P}_{RF} is the power level of the q strongest signals within the RF band. The rectified wave in a conventional multiport direct-conversion receiver can lead to the clipping of a baseband amplifier or complete symbol destruction in the data conversion process, and may have a significant impact on practical applications. Several enhanced multiport receiver architectures that compensate the dc-offset and RFS in the analog domain may require auxiliary building blocks including high power consuming tunable amplifiers and a digital-to-analog converter (DAC) components.

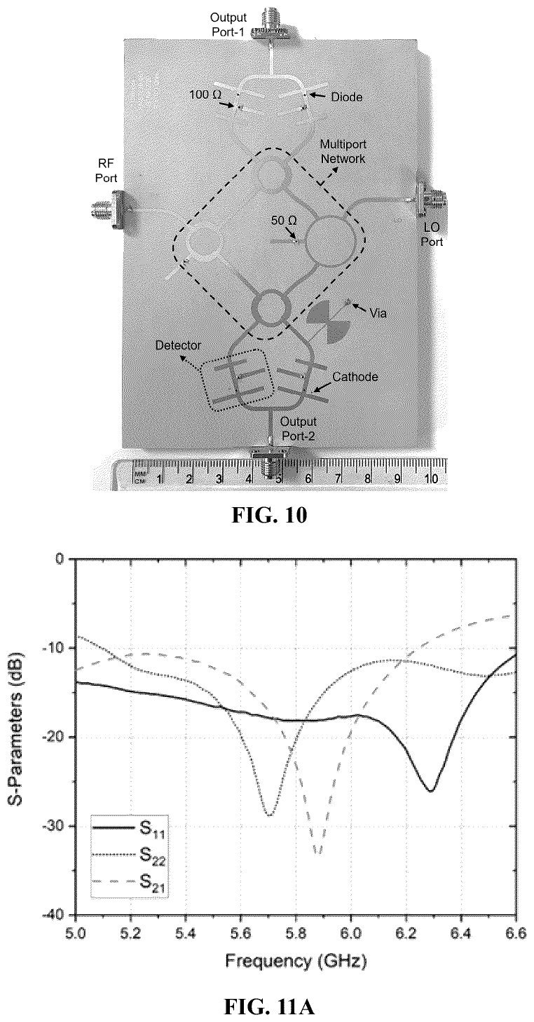

In embodiments disclosed herein, a balanced detection method in a multiport interferometric receiver may suppress the rectified wave composition for the second-order non-linearity without auxiliary building blocks in a multichannel radio propagation environment. FIG. 9A and FIG. 9B are simulated results. FIG. 9A illustrates a received signal and FIG. 9B illustrated a demodulated received signal, both signals comprising IQ-waveforms of an embodiment of the receiver disclosed herein as a function of time, wherein V₁(t) and V₂(t) are the node voltages of single-ended detected signals, when f_{LO}=60 GHz and received signal carrier frequency is 60 GHz. The balanced detection method may cancel rectified wave components while obtaining the same bit sequence at the receiver output. A balanced detection method also doubles the I/Q detected currents, which improves conversion gain by about 6 dB.

### Prototype Test Results

FIG. 10 illustrates a prototype of an embodiment of the receiver module disclosed herein which was designed and fabricated to operate in the frequency band of 5.8 GHz to validate theoretical results and evaluate the performance of the architecture described. A power detector circuit was designed using a Schottky diode, which comprises an input impedance matching network and an output network. Parasitic effects of a diode package were estimated using measured complex input impedance over a range of input power. An impedance matching network comprising a 100Ω resistor provided a resistive input impedance for wideband operation and a butterfly stub connected to a metalized via-hole through a high impedance quarter-wave microstrip line for direct current (dc) path. A pair of quarter-wave reflectors were used at the diode output for suppressing undesired high frequency components.

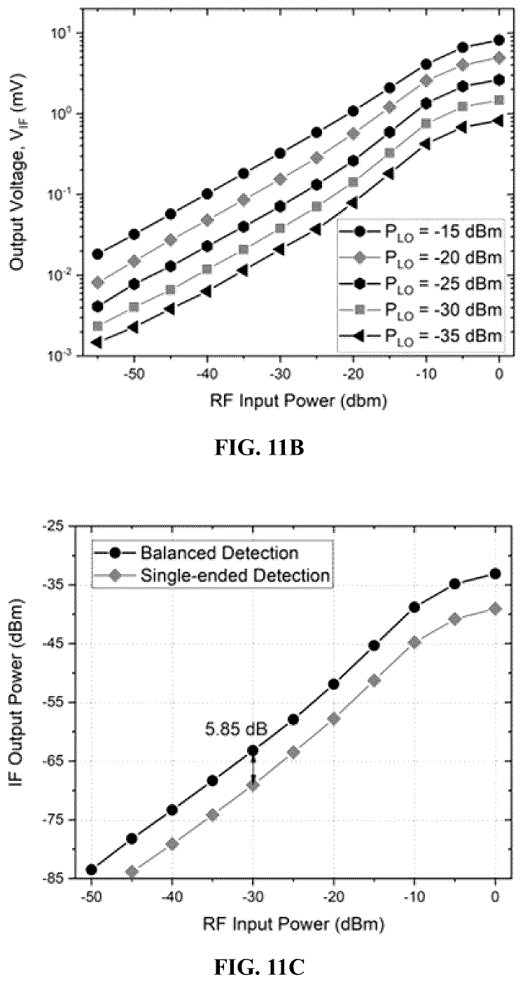

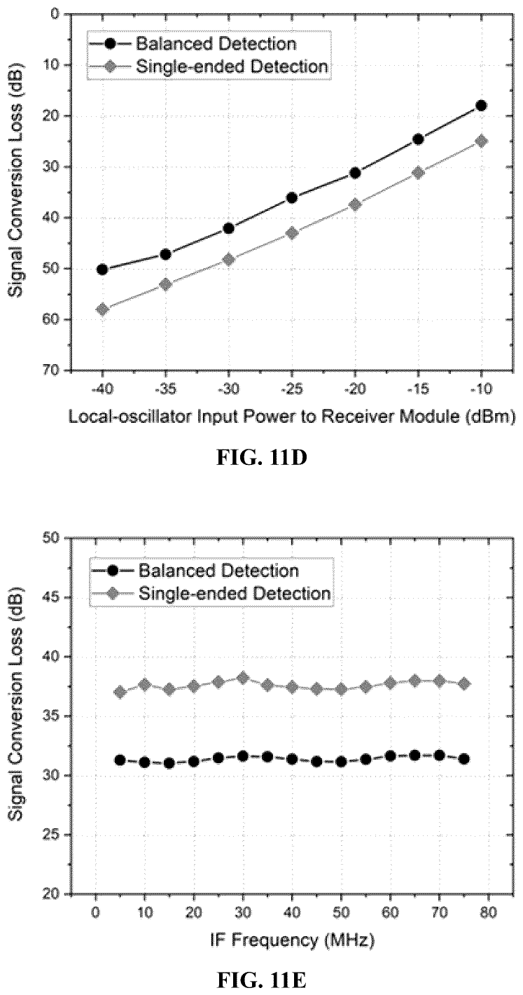

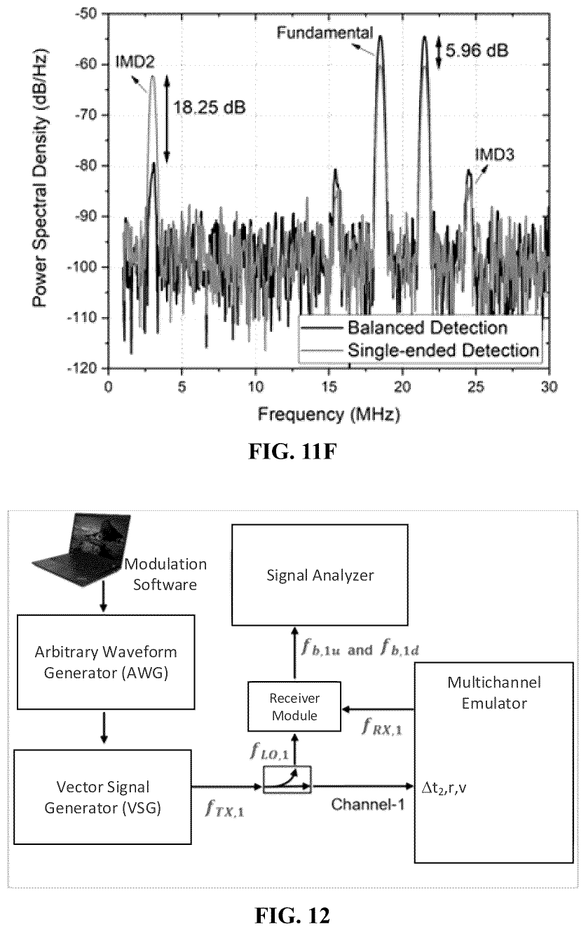

FIG. 11A to FIG. 11F show measured characteristics of the prototyped receiver module with the balanced and single-ended detection methods for comparing their conversion gain and suppression of second-order distortion performances. FIG. 11A illustrates S-parameters of the receiver module with a balanced detection method including return loss and isolation, wherein port 1 is for an RF-signal and port 2 is for a LO-signal. FIG. 11B illustrates output voltage of the receiver module with a balanced detection method when f_{LO}=5.8 GHz and f_{IF}=20 MHz. FIG. 11C illustrates output signal-power of the receiver module with single-ended and balanced detection methods when P_{LO}=−20 dBm at 5.8 GHz and f_{IF}=20 MHz. FIG. 11D illustrates signal conversion loss characteristics of the receiver module with single-ended and balanced detection methods for different power levels of the LO-signal when P_{RF}=−20 dBm, f_{LO}=5.8 GHz and f_{IF}=20 MHz. FIG. 11E illustrates signal conversion loss characteristics of the receiver module with single-ended and balanced detection methods at different IF-frequencies when P_{RF}=−20 dBm and f_{LO}=5.8 GHz at −20 dBm. FIG. 11F illustrates power spectral density of down-converted IF-signals of the receiver module with single-ended and balanced detection methods when P_{LO}=−20 dBm at 5.8 GHz and two-tone RF frequencies with P_{RF}=−20 dBm at 5.82 GHz (frequency spacing=3 MHz).

A network analyzer was used to directly perform two-port S-parameter measurements of the receiver module from 5 to 6.6 GHz. The measured S-parameter of the receiver module with the balanced detection method shows a return loss of around 18 dB for the RF port and 20 dB for the LO port, and an RF-to-LO isolation of around 23 dB at 5.8 GHz. The measurements of the receiver module were conducted with vector signal generators (VSGs), a signal analyzer, and an oscilloscope. The LO driving signal power level was selected according to voltage responsivity and conversion gain requirements of the application under consideration. It was observed that the IF signal compresses sooner with a low drive signal power. It was observed that the balanced detection method doubles the detected signal, which improves its conversion performance by 6 dB when compared to an interferometric receiver with a single-ended detection method. To demonstrate the linearization effect of the balanced detection method, two-tone signals are used as the input RF-signal and the detected IF-signals with the balanced and single-ended detection methods are analyzed. Both the fundamental and third-order intermodulation distortion (IMD3) terms were generated, and their conversion gain increased by about 6 dB with the balanced detection method, so the third-order intercept point remains almost the same as in the single-ended detection method. The second-order distortion (IMD2) was significantly suppressed to −79.40 dBm, 18.25 dB lower than observed with the single-ended detection method. Circuit balancing can be improved by considering the fabrication errors and diode responsivities.

To confirm system performance for both radar and radio communication modes, a system prototype comprising two stations was been subjected to a number of tests. The following Table 1 provides parameters used for the measurements described above. The channel bandwidth of 150 MHz was considered for the prototyping to have a desired range resolution, which is inversely proportional to the bandwidth, i.e. ΔR=c/(2BW)

TABLE 1

| Mode | Specifications | Values |
|---|---|---|
| | Frequency Range | 5725 to 5875 MHz |
| | Channel Bandwidth | 150 MHz |
| Radar | Signal Type | Triangular Sweep |
| | Sweep Time, Tᵣ | 20 ms |
| | Range Resolution | 1 m |
| | Maximum Target Range | 300 m |
| | Maximum Target Speed | 230 km/h (63.83 m/s) |
| Radio | Maximum Communication Range | 300 m |
| | Signal Type | QPSK and QAM-M |
| | | M ϵ 16, 32, 64 |
| | Sample Rate | 0.5, 1, 5, 10, 15 MS/s |

System performance in the radar mode was measured using a test bench as shown in FIG. 12, comprising software used to generate a radar waveform, which is downloaded to an AWG and upconverted in a frequency band of interest using a VSG. A multichannel emulator was configured to have a time delay Δt₂ of 0.399 msec, and a set of distances and relative velocities between a first station and a second station. Detected interferometric signals at the output of the receiver module were probed using a signal analyzer.

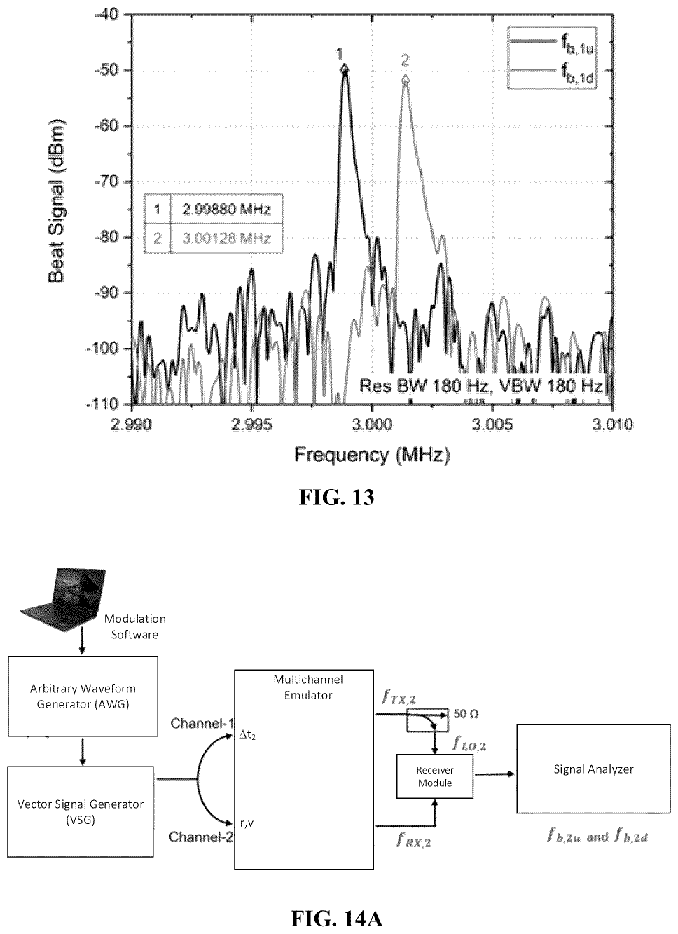

For the beat signals measurements at a first station, the channel emulator was used to emulate the receiver signal at a first station from a second station by configuring its channel-1 with a time delay and selected distance and velocity. FIG. 13 illustrates power spectral density of the beat signal at the receiver output, when Δt₂=0.399 msec, r=300 m, v=63.83 m/s (approaching target), P_{LO}=−20 dBm and P_{RF}=−20 dBm. The RF-signal and LO-signal were modeled in a manner corresponding to FIG. 2. The detected beat signals in the upchirp and downchirp were obtained at the output port of the prototyped receiver module. FIG. 13 illustrates IF spectra for a distance of 300 m and a velocity of 63.83 m/s. The beat frequencies using equations (6) and (7) at a first station are used to determine the velocity and distance between the stations.

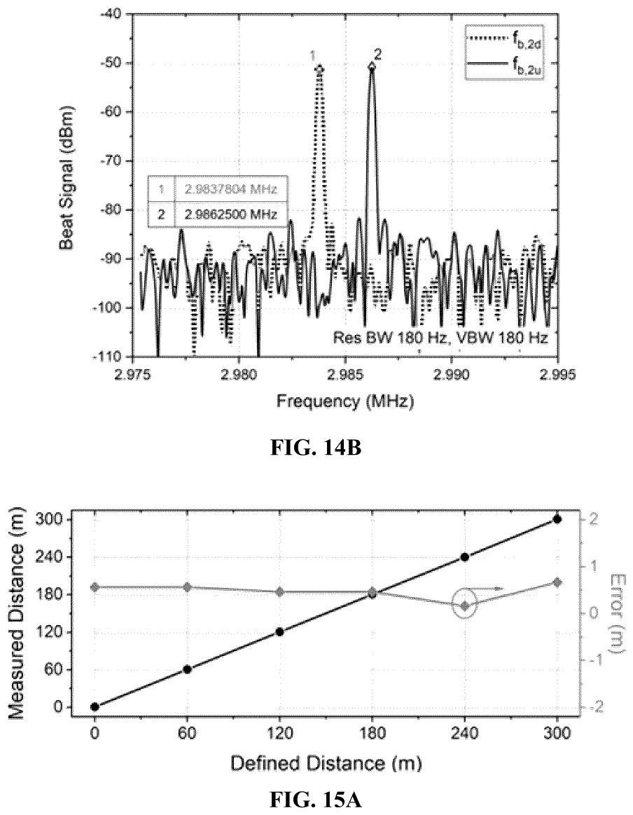

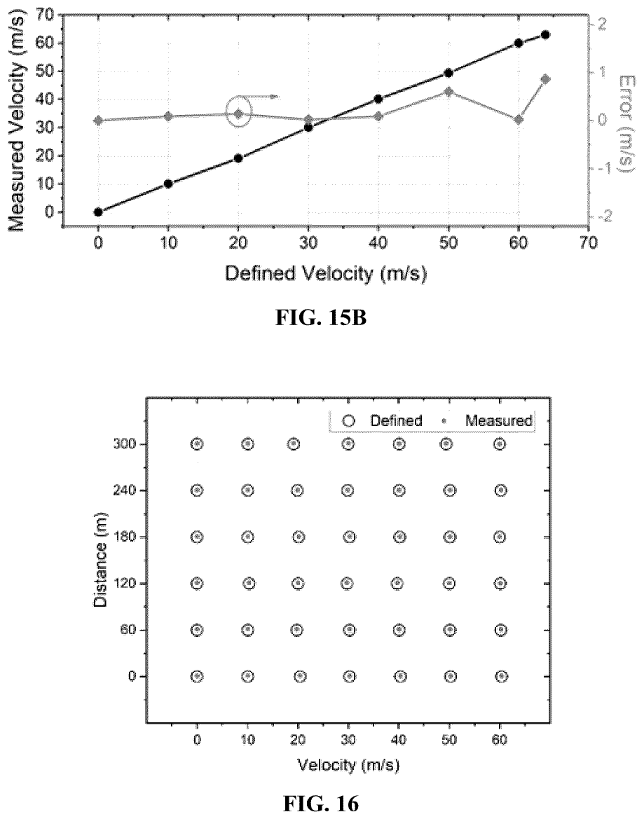

To measure beat signals at a second station, two channels of the channel emulator were used to emulate a time delay for generating the reference signal, and selected distance and velocity for generating the received signal, as shown in the block diagram of FIG. 14A. FIG. 14B illustrates the power spectral density at the receiver output, when Δt₂=0.399 msec, r=300 m, v=63.83 m/s (approaching target), P_{LO}=−20 dBm and P_{RF}=−20 dBm. The RF-signal and LO-signal were modeled in a manner corresponding to FIG. 2, which are then fed into the prototyped receiver module for measuring the beat signals in the upchirp and downchirp. These beat frequencies were communicated between the two stations in the radio cycle for velocity and distance measurements using equations (6) and (7). FIG. 15A and FIG. 15B illustrate the accuracy achieved in measurements with increasing distance and velocity between the two stations when Δt₂=0.399 msec, P_{LO}=−20 dBm and P_{RF}=−20 dBm. FIG. 15A illustrates distance measurements when v=63.83 m/s (approaching target), and FIG. 15B illustrates velocity measurements when r=300 m. The bias was determined using distances and velocities defined by the channel emulator as true values. Both the defined and measured distances and velocities between the two stations are shown in FIG. 16, which illustrates distance-velocity measurements for an approaching target, when Δt₂=0.399 msec, P_{LO}=−20 dBm and P_{RF}=−20 dBm, which demonstrates the target finding capability of an embodiment of the system disclosed herein.

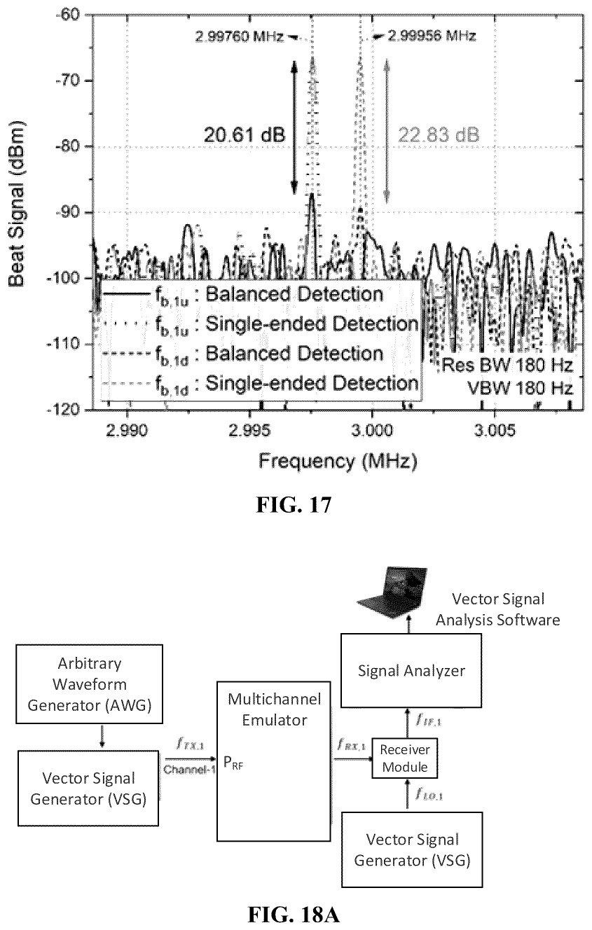

FIG. 17 illustrates IF-signals of frequency mixing between cooperative radar and radar echoes responses at a first station. The channel emulator is used to emulate the cooperative radar and radar echo responses using its channel-1 and channel-2, respectively, which are then combined and fed into the RF port of the receiver module. The balanced detection method of some embodiments disclosed herein suppresses frequency mixing that eliminates undesired interference and false targets, which can be further improved with circuit balancing. FIG. 17 illustrates beat signals measurements of cooperative radar response when Δt₂=0.399 msec, r=300 m, v=60 m/s (approaching target) with P_{RF}=−20 dBm, and radar echo response when r=30 m, v=5 m/s (approaching target) with P_{RF}=−20 dBm at a first station.

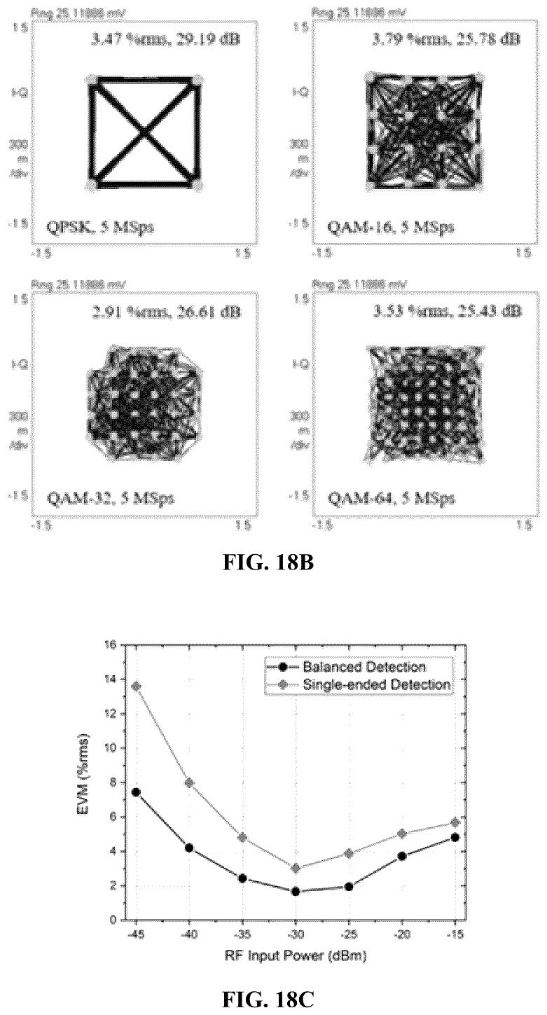

The measurement setup for evaluating the performance of the disclosed system in communication mode is illustrated in the block diagram of FIG. 18A. The RF-signal was generated by an AWG, which was upconverted in a frequency band of interest through a VSG, which was fed into a channel emulator with the configuration of the additive white Gaussian noise (AWGN) channel. The output of the channel emulator and the LO-signal from an arbitrary waveform generator were injected into the receiver module. The detected interferometric signals at the output of the receiver module were probed using a signal analyzer and analyzed in vector signal analysis software. FIG. 18B illustrates a normalized constellation diagram of recovered baseband signals of an IF channel of the receiver module with a balanced detection method when P_{LO}=−20 dBm at 5.8 GHz, P_{RF}=−20 dBm, f_{IF}=20 MHz and symbol rate=5 MSps. The rms value of the error vector magnitude (EVM) metric was computed over 500 received symbols for all modulation methods. In the case of QPSK, QAM-16, QAM-32 and QAM-64, there are 4, 16, 32 and 64 different points in the complex plane, respectively. The average EVM did not exceed 3.79% rms when the symbol rate was 5 MSps (which is equivalent to 30 Mbps for QAM-64). The EVM decreased with the increase of received signal power level, as shown in FIG. 18C, where EVM of QAM-16 signal with balanced detection and single-ended detection methods for different power levels of received signal when P_{LO}=−20 dBm at 5.8 GHz, f_{IF}=20 MHz and symbol rate=1 MSps. It saturates when the input power is around −30 dBm. With a large input power, the EVM gradually increases. The prototyped receiver module with a balanced detection method outperforms in terms of EVM metric when compared to a conventional interferometric receiver with a single-ended detection method.

The following Table 2 summarizes the measurement results for QPSK, QAM-16, QAM-32 and QAM-64 at different rates with a balanced detection method when P_{LO}=−20 dBm at 5.8 GHz, P_{RF}=−20 dBm, f_{IF}=20 MHz. The results show good performance and can further be enhanced using post-processing linearization and calibration techniques. The measurements in the communication mode were limited to the symbol rate of 15 MSps as it makes difficult to distinguish the constellation points when signals having higher bandwidths are demodulated. The maximum symbol rate is fundamentally limited by the speed of power detectors, which is linked to their rise time. Therefore, high-speed power detectors can effectively be used for higher bandwidth signals without intersymbol interference.

TABLE 2

| Signal type | Symbol rate | EVM^{a} (% rms) | SNR^{b} (dB) |
|---|---|---|---|
| QPSK | 500 kSps | 2.49 | 32.01 |
| | 1 MSps | 2.78 | 31.13 |
| | 5 MSps | 3.47 | 29.19 |
| | 10 MSps | 5.66 | 24.94 |
| | 15 MSps | 8.37 | 21.54 |
| QAM-16 | 500 kSps | 3.76 | 25.93 |
| | 1 MSps | 3.75 | 25.98 |
| | 5 MSps | 3.79 | 25.78 |
| | 10 MSps | 5.06 | 23.35 |
| | 15 MSps | 7.00 | 20.54 |
| QAM-32 | 500 kSps | 3.29 | 25.62 |
| | 1 MSps | 2.64 | 27.549 |
| | 5 MSps | 2.91 | 26.61 |
| | 10 MSps | 4.20 | 23.39 |
| | 15 MSps | 5.73 | 20.72 |
| QAM-64 | 500 kSps | 3.40 | 25.76 |
| | 1 MSps | 3.09 | 26.53 |
| | 5 MSps | 3.53 | 25.43 |
| | 10 MSps | 4.57 | 23.06 |
| | 15 MSps | 5.95 | 20.75 |

^{a}The results are free from a post-processing linearization and calibration.
^{b}signal-to-noise ratio (SNR) of the baseband signal. The spectrum span of an IF-channel is increased for higher symbol rate values.

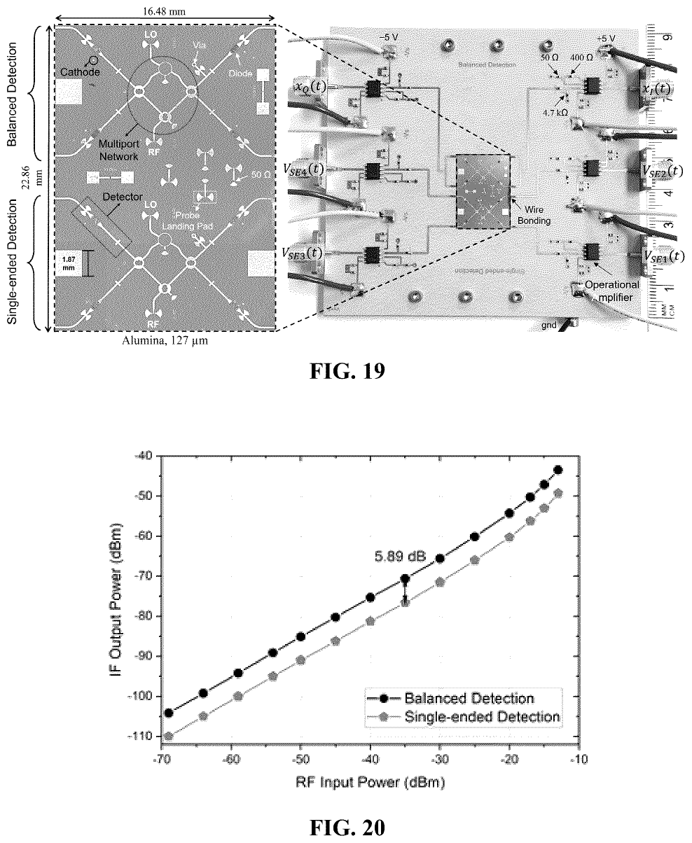

In addition, conversion characteristics, rectified wave suppression and EVM performances were experimentally studied with an embodiment of the interferometric receiver disclosed herein over the 60 GHz mmW frequency band. FIG. 19 illustrates a prototyped front-end fabricated using the microwave integrated circuit process, which is implemented on a 127 μm ceramic substrate with a relative permittivity of 9.9. The prototyped front-end comprised both the balanced and single-ended detection circuits and on alumina substrate, the 50Ω integrated resistors were implemented with a titanium layer with 100 Ω/square resistance. The receiver module incorporates both the single-ended and balanced detection circuits for comparing performance characteristics. The power detector circuit is designed using a Schottky diode, which consists of the input impedance matching network and the detected output network. The parasitic effect of the diode package was estimated using the measured complex input impedance over a range of input power. The impedance matching network has a butterfly stub connected to a metalized via-hole through a high impedance quarter-wave microstrip line for a dc path. A pair of quarter-wave reflector has been employed at the diode output for suppressing the undesired high frequency components. The power detector circuits are self-biased. The baseband circuit was realized with AD8000 operational amplifiers using a standard printed circuit board (PCB) process. It provides a gain of about 19 dB, and has an input impedance of 4.7 kΩ for improved voltage sensitivity.

Measurements were conducted with a microwave network analyzer source, VSG, a signal analyzer, an oscilloscope, and a dc power supply. The RF signal was created by mixing a 57 GHz continuous wave (CW) signal with a VSG at 3.015 GHz by means of a microwave mixer. The measurements were carried out using pairs of 150-μm-pitch GSG probes on a probe test platform. The detected interferometric signals at the output of the receiver module were used for the circuit characterization. The balanced detection method demonstrated about 6 dB of conversion gain improvement of the detected signals in contrast to a conventional multiport receiver employing a single-ended detection method for the same LO power level as illustrated in FIG. 20. FIG. 20 illustrates measured output signal-power of the receiver module with balanced and single-ended detection methods when P_{LO}=−17 dBm, f_{IF}=15 MHz and f_{LO}=60 GHz.

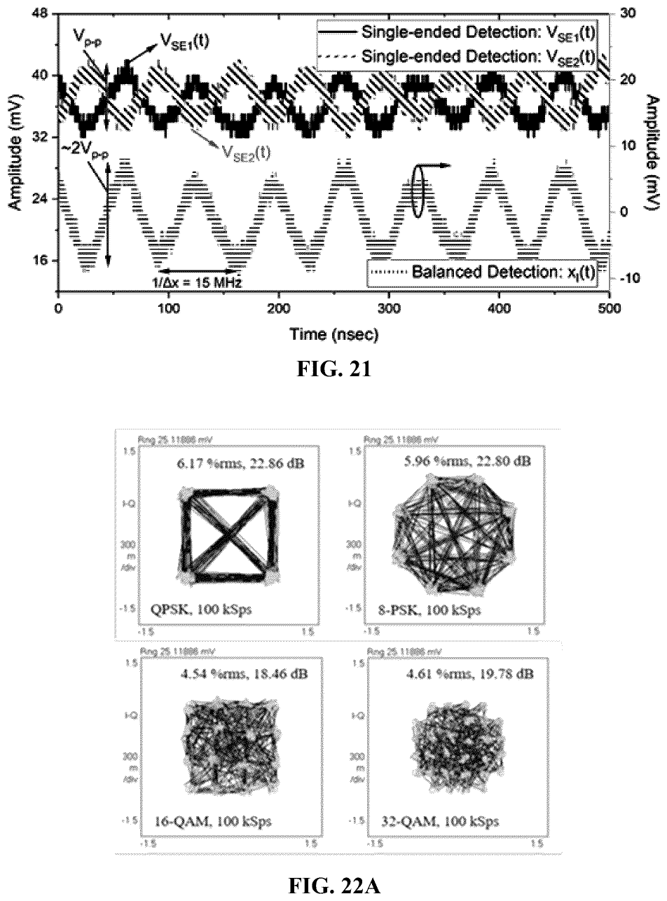

FIG. 21 illustrates output signal components probed at the output of the receiver with single-ended detection, which is dc-offset compensated to regulate the uneven power split and phase shift of the passive junction and unequal responsivities of diodes. FIG. 21 illustrates measured output IQ-signal components as a function of time, when P_{RF}=−7 dBm and P_{LO}=−21 dBm. V_{SE1}(t), V_{SE2}(t) and x_{I}(t) are the node voltages. The balanced output signal was obtained by combining these single-ended signals. The circuit balancing can be improved by considering the fabrication errors and diode responsivities. The balanced detection method doubles the detected signal, which thus improves its conversion gain by about 6 dB. It also cancels the rectified components generated from the individual power detectors, which would gain an appreciable dynamic range for the desired signal at the baseband stage.

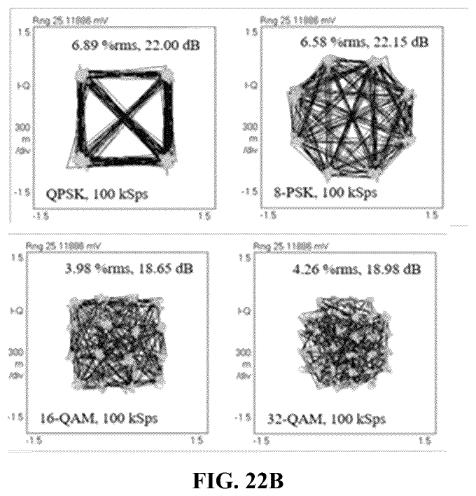

Several digital modulation methods at different symbol rates were also experimentally examined with an embodiment of the interferometric receiver disclosed herein. The detected interferometer signals with f_{IF}=15 MHz at the output of the receiver module were probed using a signal analyzer and analyzed in vector signal analysis software. The transmitted bit sequence was created using a VSG pseudorandom bit sequence generator (PRBS). FIGS. 22A and 22B shows normalized constellation diagrams of recovered baseband signals of the receiver module with single-ended detection at P_{LO}=−11 dBm (FIG. 22A) and balanced detection at P_{LO}=−17 dBm (FIG. 22B), when P_{RF}=−21 dBm, f_{IF}=15 MHz and f_{LO}=60 GHz.

The differential EVM is computed for all modulation methods over the 60 GHz mmW frequency band. In the case of QPSK, 8-PSK, 16-QAM and 32-QAM, there are 4, 8, 16 and 32 different points in the complex plane, respectively. The power of the LO driving signals was set to about −11 dBm and −17 dBm for the receiver circuits with the single-ended and balanced detection methods, respectively. The balanced detection method only requires about 25% of the reference (LO) driving signal level to have a similar EVM performance as in the case of the single-ended detection method when probing an IF detected signal.

The following Table 3 summarizes measurement results for QPSK, 8-PSK and 16-QAM at different symbol rates. The results are also compared with the mmW direct-conversion interferometric receivers with a single-ended detection method presented in the literature. It shows good performance in terms of achievable EVM values and can further be enhanced with post-processing calibration and linearization techniques. The measurements in this solution are limited to 500 kSps of symbol rate as it is fundamentally limited by the speed of power detectors, which is linked to their rise time. Therefore, high-speed power detectors can be used for higher bandwidth signals without intersymbol interference.

TABLE 3

| Ref. | Signal type | Symbol rate | EVM (% rms) | SNR^{γ} (dB) |
|---|---|---|---|---|
| [This solution]^{★a} | QPSK | 100 kSps | 6.17/6.89 | 22.86/22.00 |
| 60 GHz | | 250 kSps | 9.19/10.38 | 20.09/19.16 |
| | | 500 kSps | 12.96/14.14 | 17.74/16.71 |
| | 8-PSK | 100 kSps | 5.96/6.58 | 22.80/22.15 |
| | | 250 kSps | 9.61/9.39 | 20.01/19.75 |
| | | 500 kSps | 11.23/13.59 | 18.42/16.94 |
| | 16-QAM | 100 kSps | 4.54/3.98 | 18.46/18.65 |
| | | 250 kSps | 6.65/6.74 | 17.67/17.25 |
| | | 500 kSps | 8.37/8.94 | 16.37/16.06 |
| [35] [symbol] | QPSK | n.a.• | 12.7 | n.a.• |
| 63 GHz | 8-PSK | NEED TO SEE +108 OR +500 | 12.6 | |
| | 16-QAM | | 10.9 | |
| [36] [symbol] | 16-QAM | n.a.• | 8.0 | n.a.• |
| 62 GHz | 32-QAM | | 8.7 | |
| [4] [symbol] ^{b} | 16-QAM | 4 MSps | ~7 | 20 |
| 77 GHz | 64-QAM | | ~6 | 20 |

^{★}Single-ended detection results at P_{LO} = −11 dBm/balanced detection results at P_{LO} = −17 dBm. The spectrum span of an IF-channel is increased for higher symbol rate values.
^{γ}SNR of the detection signal. [symbol]
Receivers with a single-ended detection method, and their measurement P_{LO} is not reported.
·Results not reported.
^{a}The results are free from a post-processing linearization and calibration.
^{b}After a calibration technique based on minimum norm least-square solution

The balanced detection method also reduces baseband processing paths as compared to a conventional six-port interferometric receiver, which results in footprint and power savings in connection with the required number of filters and data converters.

Those skilled in the art will appreciate that the embodiments and examples described above are for demonstration purposes only. For example, some embodiments are described with specific frequencies which are for demonstration purposes only, and in other embodiments, other or even all RF frequencies may be used.

Although embodiments have been described above with reference to the accompanying drawings, those of skill in the art will appreciate that variations and modifications may be made without departing from the scope thereof as defined by the appended claims.

1. A module comprising:
a transmitter for transmitting an originating radar sweep signal to a cooperating module; and
a receiver for receiving a cooperating radar sweep signal from the cooperating module;
wherein the module is configured for:
processing the cooperating radar sweep signal to determine a distance between the module and the cooperating module and a velocity of the cooperating module relative to the module.

2. The module of claim 1, wherein the receiver is an interferometric receiver.

3. The module of claim 1, wherein the transmitter is configured for transmitting the originating radar sweep signal and an originating radio signal to a cooperating module in different first time slots;
wherein the receiver is configured for receiving the cooperating radar sweep signal and a cooperating radio signal transmitted from the cooperating module in different second time slots; and
wherein the module is further configured for:
processing the cooperating radio signal to extract cooperating radio signal data.

4. The module of claim 1, wherein the module comprises balanced radar detection for processing the cooperating radar sweep signal, balanced radio detection for processing the cooperating radio signal, or a combination thereof.

5. The module of claim 1, wherein the different first time slots and the different second time slots are each arranged based on a time-division multiple access (TDMA) method.

6. The module of claim 1, wherein the originating and cooperating radar sweep signals are triangular frequency-modulated continuous waves.

7. The module of claim 1, wherein the transmitter is configured to transmit the originating radar sweep signal after an originating time delay following a start of one of the first time slots.

8. The module of claim 1, wherein the module is configured to extract a cooperating time delay from the cooperating radar sweep signal, the cooperating time delay being distinctly associated with a particular cooperating module.

9. The module of claim 1, wherein the cooperating radio signal data comprises beat frequency information of the cooperating radar sweep signal.

10. A method comprising:
in a first time slot, transmitting an originating radar sweep signal from a module to a cooperating module and sensing for a cooperating radar sweep signal from the cooperating module; and
in a second time slot, transmitting an originating radio signal from the module to the cooperating module and sensing for a cooperating radio signal from the cooperating module.

11. The method of claim 10, wherein:
the originating radar sweep signal is transmitted to one or more cooperating modules;
the cooperating radar sweep signal is from one cooperating module of the one or more cooperating modules;
the originating radio signal is transmitted to the one more cooperating modules; and
the cooperating radio signal is from one cooperating module of the one or more cooperating modules.

12. The method of claim 10, further comprising the step of receiving and processing the cooperating radar sweep signal to determine a distance between the module and the cooperating module and a velocity of the cooperating module relative to the module.

13. The method of claim 12, wherein processing the cooperating radar sweep signal comprises balanced radar detection.

14. The method of claim 10, further comprising the step of receiving and processing the cooperating radio signal to extract cooperating radio signal data.

15. The method of claim 14, wherein processing the cooperating radio signal comprises balanced radio detection.

16. The method of claim 10, wherein the first time slots and the second time slots are arranged based on a TDMA method.

17. The method of claim 10, wherein the originating and cooperating radar sweep signals are triangular frequency-modulated continuous waves.

18. The method of claim 10, wherein the originating radar sweep signal is transmitted after an originating time delay following a start of the first time slot.

19. The method of claim 12, further comprising the step of extracting a cooperating time delay from the cooperating radar sweep signal, the cooperating time delay being distinctly associated with a particular cooperating module.

20. The method of claim 14, wherein the cooperating radio signal data comprises beat frequency information of the cooperating radar sweep signal.
